(19) United States
(12) Patent Application Publication
(10) Pub. No.: US 2026/0011807 A1
(43) Pub. Date: Jan. 8, 2026

(54) BATTERY CELL HEAT TRANSFER CIRCUIT INCORPORATED INTO THE BASE OF THE BATTERY AND ASSOCIATED MANUFACTURING METHOD

(71) Applicant: SAFRAN ELECTRICAL & POWER, Blagnac Cedex (FR)

(72) Inventors: Frédéric Pinard, Moissy Cramayel (FR); Kevin Kappler, Moissy Cramayel (FR); Sébastien Thomassier, Moissy Cramayel (FR)

(73) Assignee: SAFRAN ELECTRICAL & POWER, Blagnac Cedex (FR)

(21) Appl. No.: 19/126,502

(22) PCT Filed: Oct. 31, 2023
(86) PCT No.: PCT/FR2023/051717

§ 371 Date: May 1, 2025

(30) Foreign Application Priority Data
Nov. 7, 2022 (FR) 2211554

(51) Int. Cl. H01M 10/613; H01M 10/617; H01M 10/6556; H01M 10/6565; H01M 10/6568

(52) U.S. Cl. CPC H01M 10/613; H01M 10/617; H01M 10/6556; H01M 10/6565; H01M 10/6568

(57) ABSTRACT

Battery support comprising a base and a heat transfer circuit, the heat transfer circuit comprising a first duct and a second duct, a first end of the first duct allowing a heat transfer liquid to be received, a first end of the second duct allowing said heat transfer liquid to be discharged, the first duct and the second duct being connected together by the second end thereof, the first duct and the second duct being delimited on the one hand by the base and on the other hand by a set of walls, the first duct and the second duct sharing a common wall.

### TECHNICAL FIELD

The technical field of the invention is the protection of multiple cell batteries, and more particularly the protection of such batteries against thermal runaway.

### PRIOR ART

The electrochemical cells of a battery are generally assembled inside a casing, in contact with a heat transfer circuit, wherein a heat transfer liquid circulates.

Such a casing generally comprises a tray or base and a bell cooperating with the base in order to delimit a closed volume within which the cells of the battery are disposed.

The heat transfer circuit is in contact with the base and is in the form of a set of welded tubes, generally connected in parallel. When they are connected in this way, the flow of heat transfer fluid is substantially equal through each tube. However, such a configuration has the effect of creating a thermal gradient between the input and the output of the circuit.

In some configurations, not all cells can be cooled in parallel. The heat transfer circuit then comprises tubes connected in parallel and tubes connected in series. In combination with the temperature gradient of the parallel zones, this has the effect of not subjecting all of the cells to a heat transfer fluid at the same temperature. Some cells then have a higher temperature than other cells. The same applies when a large number of cells are cooled by a parallel circuit, the cells near the inlet of the heat transfer circuit have a lower temperature than those near the outlet.

This situation is detrimental because the temperature of a cell has a direct impact on the lifespan thereof, and more particularly on the ageing of the cell. In a battery comprising a plurality of cells, a differentiated ageing of the cells is problematic because it can lead to premature failure of the cells having seen the highest temperatures. Such failures require specific maintenance operations.

Moreover, the heat transfer circuit is generally independent of the base so as to facilitate the manufacture, control and maintenance thereof.

This has the disadvantage of increasing the weight of the assembly, increasing the number of parts to be managed and requiring the use of a thermal interface between the base and the heat transfer circuit in order to compensate for the mechanical play between the two parts and promote heat exchanges. This thermal interface is generally produced in the form of a thermal pad, which has an impact on the weight and cost of the assembly.

There is a need to reduce the weight of a battery and the heat transfer system thereof, particularly from an aeronautical application perspective.

There is also a need to reduce the temperature gradient between the various cells.

### DESCRIPTION OF THE INVENTION

The object of the invention is a battery support comprising a base and a heat transfer circuit, the heat transfer circuit comprising a first duct and a second duct, a first end of the first duct allowing a heat transfer liquid to be received, a first end of the second duct allowing said heat transfer liquid to be discharged, the first duct and the second duct being connected together by the second end thereof. The first duct and the second duct are delimited on the one hand by the base and on the other hand by a set of walls, the first duct and the second duct sharing a common wall. The cross-section of the walls of the heat transfer circuit may be E-shaped. The cross-section of the walls of the heat transfer circuit may be W-shaped. Another object of the invention is a battery comprising at least one cell disposed on a battery support as described above, the cells being disposed on one side of the base, the heat transfer circuit being disposed on the other side of the base so as to extend opposite each cell.

The heat transfer liquid may be selected from a refrigerant, glycol water, or a gas, in particular air.

Another object of the invention is a method for manufacturing a battery support as described above, comprising the following steps:
a base and a heat transfer circuit are manufactured,
the heat transfer circuit is disposed on the base,
a holding tool is subsequently attached to the base so that it extends above the heat transfer circuit,
the pressure exerted by the holding tool on the heat transfer circuit is then adjusted so as to reduce the distance between the walls of the heat transfer circuit and the base,
laser welding of the walls of the heat transfer circuit and the base is performed,
the holding tool is removed,
the holes possibly arranged in the base to attach the holding tool are closed by disposing and welding for each of them a shouldered washer or a metal pad.

One object of the invention is a method for manufacturing a battery support as described above, wherein the heat transfer circuit is produced by additive manufacturing directly on the base.

### BRIEF DESCRIPTION OF THE DRAWINGS

Other aims, features and advantages of the invention will become apparent upon reading the following description, given solely as a non-limiting example and with reference to the appended drawings wherein:

FIG. 1 illustrates a first embodiment of a heat transfer circuit,

FIG. 2 illustrates a sectional view of the heat transfer circuit,

FIG. 3 illustrates a sectional view of the cross-section of the heat transfer circuit,

FIG. 4 illustrates a tool for holding the heat transfer circuit on the base during welding,

FIG. 5 illustrates the main steps of a method for manufacturing a heat transfer circuit according to the first embodiment,

FIG. 6 illustrates a sectional view of the cross-section of the heat transfer circuit according to a second embodiment, and

FIG. 7 illustrates the second embodiment of a heat transfer circuit,

### DETAILED DESCRIPTION

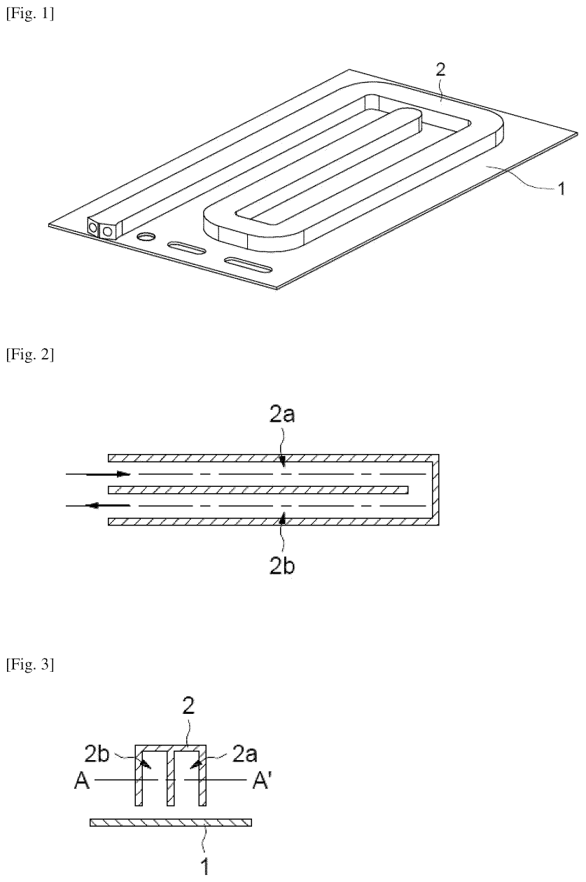

A battery casing according to the invention comprises a bell and a base at the surface of which the heat transfer circuit is welded. [FIG. 1] illustrates the base 1 and the heat transfer circuit 2.

The heat transfer circuit comprises a first duct 2a wherein the liquid received in the circuit flows and a second duct 2b wherein the liquid discharged from the heat transfer circuit 2 flows. The heat transfer fluid is received in the first duct 2a through the first end thereof. The heat transfer liquid is also discharged from the second duct 2b through the first end thereof. The heat transfer liquid is selected from a refrigerant liquid, glycol water, or even a gas such as air.

The two ducts are connected together by the second end thereof.

In order to homogenise the temperatures between the battery cells, the inventors had the idea of sharing a wall between the two ducts. [FIG. 2] illustrates a sectional view according to a plane passing through a central axis of each duct.

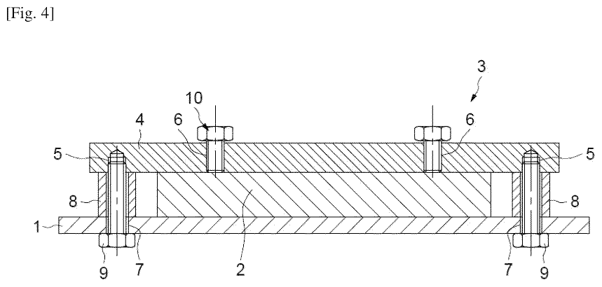

In order to reduce the weight of the battery casing and increase the transfer efficiency, the inventors had the idea of removing the wall of the heat transfer circuit 2 in contact with the base. It is thus possible to save money on the wall of the heat transfer circuit at the interface with the base 1. The weight of the assembly as well as the thermal inertia of the assembly, facilitating heat transfers is thus reduced. [FIG. 3] illustrates a sectional view normal to the axes of each duct. The sectional plane A-A′ of [FIG. 2] is illustrated, as well as the base 1, the first duct 2a and the second duct 2b.

It follows from this removal that the heat transfer circuit 2 comprises an open face and an E-shape. The ducts 2a, 2b are thus only able to receive the heat transfer liquid once they are secured to the base 1.

It should be noted that the E-shape of the heat transfer circuit corresponds to the requirements in terms of thermal management of the cells, in particular in terms of heat transfer. Knowing the heat capacity of the heat transfer fluid used, and the amount of thermal energy to be dissipated, it is possible to determine the required flow rate of heat transfer fluid. Knowing the capacity of the on-board circulation pumps, it is possible to determine the required cross-section of the ducts of the heat transfer circuit. The cross-section of the heat transfer circuit can be modified, particularly in terms of the form ratio, to take into account the structural constraints of the ducts. In particular, the height of the coil can be adapted according to bending or torsional resistance.

It follows from the above considerations that the first duct wherein the received liquid flows and the second duct wherein the discharged liquid flows are both in contact with the same components, particularly with the same cells. Combined with the common wall, this has the advantage of homogenising the temperature between the received heat transfer liquid and the discharged heat transfer fluid so that the temperature gradient is reduced. In addition, the removal of the wall of the ducts in contact with the base makes it possible to prevent a double interface due to the contact of the wall of the ducts with the base. The thermal inertia is reduced, which further reduces the temperature gradient.

In a particular embodiment, the heat transfer circuit is designed so as to be in contact with the electrical connectors of the battery.

A method for manufacturing the heat transfer circuit described above will now be described.

The E-section of the heat transfer circuit, illustrated in [FIG. 3], shows the limited accessibility of the central wall of the heat transfer circuit 2 when welding on the base 1.

In a first embodiment, the heat transfer circuit is welded to the base by laser welding. Such welding is performed through transparency, so that the limited accessibility of the central wall is not problematic. It also has the advantage of not requiring any metal addition, and therefore no weight addition.

However, one of the main constraints of laser welding is the distance between the parts to be welded, in this case between the walls and the base. This distance should be less than 0.2 mm with current techniques.

In order to ensure that this constraint is respected between the walls of the heat transfer circuit and the base, a holding tool has been developed. [FIG. 4] illustrates this holding tool 3, which comprises a metal plate 4 provided with a first set 5 of blind tapped holes disposed opposite the base 1 and a second set 6 of through tapped holes disposed above the heat transfer circuit 2.

A set of holes 7 is produced in the base 1, opposite the first set 5 of blind tapped holes. The tool and the base are subsequently secured by means of spacers 8 adjusted to the height of the heat transfer circuit 2 and screws 9. Alternatively, sets of threaded rod and nut pairs are substituted for screws 9.

The second set of holes 6 is provided with other screws 10, the screwing of which makes it possible to apply pressure to the heat transfer circuit 2. This pressure makes it possible to reduce the distance between the walls of the heat transfer circuit 2 and the base 1, below the limit distance for laser welding.

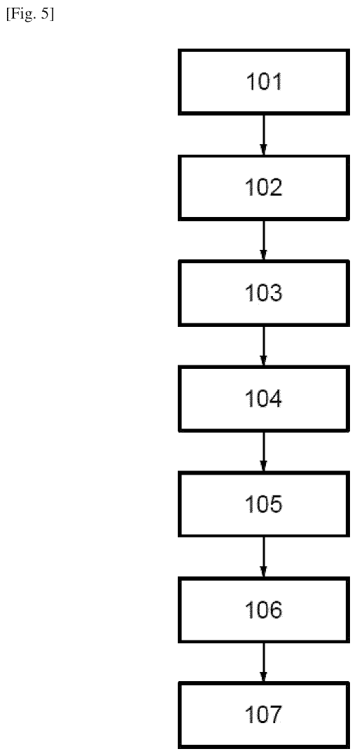

The manufacturing process is illustrated in [FIG. 5]. It comprises a first step 101 during which the heat transfer circuit 2 is disposed on the base 1. The holding tool 3 is subsequently attached to the base 1 so that it extends above the heat transfer circuit 2, the screws 10 being in contact with the heat transfer circuit 2. The pressure on the heat transfer circuit 2 is then adjusted by adjusting the screwing of the screws 10 so as to reduce the distance between the walls of the heat transfer circuit 2 and the base 1.

During a second step 102, laser welding is performed. During a third step 103, the holding tool is removed. During a fourth step 104, each tapped hole 7 arranged in the base 1 and allowing the holding tool to be attached is then provided with a shouldered washer or a metal pad which is also welded by laser welding.

The choice of the layout and the number of holes of the first assembly 5 depends, among other things, on the length of the heat transfer circuit 2, of the shape thereof and the deformation of the base 1.

It should be noted that laser welding makes it possible to weld parts made of titanium, which is a material with very good mechanical resistance. The construction of the titanium heat transfer circuit is particularly interesting due to the mechanical stresses it undergoes during cooling or heating of the battery cells, and due to the stiffness conferred by the heat transfer circuit 2 to the base 1. Finally, with the same dimensions, titanium has a lower weight than stainless steel.

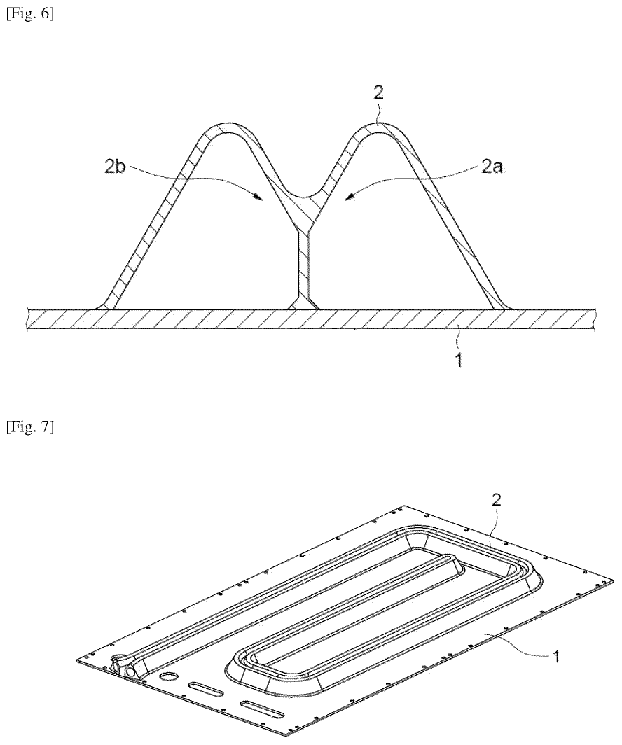

In another implementation of the manufacturing method, the heat transfer circuit is produced by additive manufacturing directly on the base. In order to take into account the constraints specific to such additive manufacturing, the E-shape is replaced by a W-shape wherein each duct 2a,2b is triangle-shaped. [FIG. 6] illustrates the W-shape of the heat transfer circuit 2 while [FIG. 7] is a plunge view of the heat transfer circuit 2 formed on the base 1 by additive manufacturing.

The above description illustrates the cooling of battery cells. Nevertheless, it is known that heating such cells can also be beneficial, particularly in the context of low-temperature charging. Such an embodiment is also included within the scope of the invention insofar as it differs only by a heat input carried out by means of the circulation of a heated heat transfer liquid instead of the heat removal carried out by means of the circulation of a cooled heat transfer liquid described above.

1. Battery support comprising a base and a heat transfer circuit, the heat transfer circuit comprising a first duct and a second duct, a first end of the first duct allowing a heat transfer liquid to be received, a first end of the second duct allowing said heat transfer liquid to be discharged, the first duct and the second duct being connected together by the second end thereof, wherein the first duct and the second duct are delimited on the one hand by the base and on the other hand by a set of walls, the first duct and the second duct sharing a common wall, the cross-section of the walls of the heat transfer circuit is W-shaped, the heat transfer circuit being produced by additive manufacturing.

2. Battery comprising at least one cell disposed on a battery support as claimed in claim 1, the cells being disposed on one side of the base, the heat transfer circuit being disposed on the other side of the base so as to extend opposite each cell.

3. Battery according to claim 2, wherein the heat transfer liquid is selected from a refrigerant, glycol water, or a gas.

4. Method for manufacturing a battery support as claimed in claim 1, during which the heat transfer circuit is produced by additive manufacturing directly on the base.

5. Battery according to claim 2, wherein the heat transfer liquid is air.
